(19) United States
(12) Patent Application Publication
(10) Pub. No.: US 2005/0142058 A1
(43) Pub. Date: Jun. 30, 2005

(54) Low temperature process for preparing tricobalt tetraoxide

(75) Inventors: Dzu-Chi Lee, Hsinchu (TW); Jiunn-Ren Lin, Hsinchu (TW); Jer-Yuan Shiu, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/747,130

(22) Filed: Dec. 30, 2003

(51) Int. Cl. C01G 51/04

(52) U.S. Cl. 423/594.19

(57) ABSTRACT

The process of the present invention includes introducing a reaction mixture formed by mixing a precipitation agent with an aqueous solution of cobalt sulfate, cobalt chloride or cobalt nitrate into an autoclave or reactor equipped with a refluxing device directly without filtration, and conducting an oxidation reaction at a temperature of 50-100° C. and in the presence of an oxidant to form a tricobalt tetraoxide powder.

### FIELD OF THE INVENTION

The present invention is related to a process of the preparation of tricobalt tetraoxide, and in particular to a process for preparing a tricobalt tetraoxide powder at a relatively lower temperature.

### BACKGROUND OF THE INVENTION

Due to their extraordinary energy density, rechargeable lithium ion batteries are presently attracting attention as rechargeable power sources for use in portable electronic/electric devices such as portable telephones and notebook-type personal computers. The current rechargeable lithium ion batteries mostly employ a lithium cobalt oxide (LiCoO₂) as a cathode material. The lithium cobalt oxide has conventionally been synthesized by firing a mixture of tricobalt tetraoxide with lithium carbonate in the air. Accordingly, a demand of tricobalt tetraoxide has been increasing in the market.

The conventional process for preparing tricobalt tetraoxide uses a water soluble cobaltous sulfate as a starting material, and sodium carbonate or sodium hydrogen carbonate as a precipitation agent to form a precipitate, which is recovered by filtration, followed by water washing, drying and calcination at a temperature higher than 300° C. to form tricobalt tetraoxide. Similar processes can be seen in Japanese patent Nos. JP5506281, JP2208227, JP2311318, JP4321523, JP922692, JP08096809, and JP11292548. The main difference in these patents is the precipitation agents used, such as oxalic acid, ammonium oxalate or ammonium hydroxide. A common drawback of these prior art processes is that they all require a high temperature calcination step to form tricobalt tetraoxide, which is not energy efficient.

### SUMMARY OF THE INVENTION

The primary objective of the present invention is to provide a low temperature oxidation process for preparing tricobalt tetraoxide.

The process of the present invention includes mixing a precipitation agent with an aqueous solution of cobalt sulfate, cobalt chloride or cobalt nitrate, and introducing the resulting mixture into an autoclave or reactor equipped with a refluxing device directly without filtration, and conducting an oxidation reaction at a temperature of 50-100° C. and in the presence of an oxidant to form a tricobalt tetraoxide powder, which is recovered by filtration, followed by water washing and drying.

### BRIEF DESCRIPTION OF DRAWINGS

FIG. 1 shows the X-ray diffraction (XRD) spectra of the tricobalt tetraoxid powders prepared in Example 1 of the present invention and prepared by the conventional calcination process.

FIG. 2 shows a scanning electron microscope (SEM) photograph of the tricobalt tetraoxide powder prepared in Example 1 of the present invention.

### DETAILED DESCRIPTION OF THE INVENTION

The present invention discloses a process for preparing tricobalt tetraoxide at a relatively lower temperature. The tricobalt tetraoxide is useful in making the cathode of the lithium ion battery, a magnetic material, a glaze and a catalyst.

The process for preparing tricobalt tetraoxide according to the present invention comprises the following steps:
a) reacting a water soluble cobaltous compound and a alkali metal hydroxide, alkali metal salt, ammonium hydroxide or ammonium salt in water to form cobaltous hydroxide;
b) reacting the resulting reaction mixture from step a) and an oxidant at a temperature of 50-100° C. and under refluxing or under a hermetic high pressure condition to form a tricobalt tetraoxide powder;
c) solid-liquid separation of the resulting reaction mixture from step b); and
d) washing the powder recovered from step c) with water, preferably with deionized water, and drying the washed powder, preferably at a temperature of about 100° C.

Preferably, step a) comprises reacting cobaltous sulfate, cobaltous chloride or cobaltous nitrate and sodium hydroxide, sodium carbonate, or sodium hydrogen carbonate, more preferably sodium hydroxide, at a pH value of 10-13, more preferably at a pH value of 11-12.

Preferably, said oxidant in step b) is oxygen, potassium permanganate, potassium perchlorate or hydrogen peroxide.

Preferably, said oxidant in step b) is oxygen, and said reaction in step b) is carried out at a temperature of 90-100° C. and under refluxing.

Preferably, said oxidant in step b) is potassium perchlorate, and said reaction in step b) is carried out at a temperature of 90-100° C. and under refluxing.

Preferably, said oxidant in step b) is oxygen, and said reaction in step b) is carried out at a temperature of 90-100° C. and in an autoclave.

Preferably, said solid-liquid separation in step c) is filtration, and more preferably filtration with vacuuming.

Preferably, said tricobalt tetraoxide powder has substantially spherical grains with an average diameter less than 200 nm.

The reaction in step b) may be carried out in an autoclave or a reactor equipped with a refluxing device. To the resulting reaction mixture from step a) in the autoclave, the oxidant is introduced. The autoclave is air-tight, so that a pressure in the autoclave will be built up while the reaction is undergoing. The reaction in step b) may be carried out in a reactor equipped with a refluxing device, in which the oxidant and the resulting reaction mixture from step a) are reacted under refluxing.

### EXAMPLE 1

22.488 g cobaltous sulfate (CoSO₄.7H₂O, molecular weight 281.11, available from MECHEMA CHEMICALS INTERNATIONAL CORP., Taiwan) was dissolved in 100 ml deionized water by stirring. 4.8 g sodium hydroxide was dissolved in 100 ml deionized water by stirring. The two solutions were mixed and stirred for 24 hours to complete the precipitation reaction. The reaction mixture was introduced to a reactor equipped with a refluxing device, and oxygen was introduced into the reaction mixture at a flow rate of 2 l/min for 24 hours, wherein the reactor was heated with an oil bath at a temperature of 90˜100° C. The resulting oxidation mixture was filtered under vacuuming, the filtered cake was washed with deionized water to remove ionic impurity, followed by drying at 100° C. for 12 hours to obtain a black loose powder of tricobalt tetraoxide.

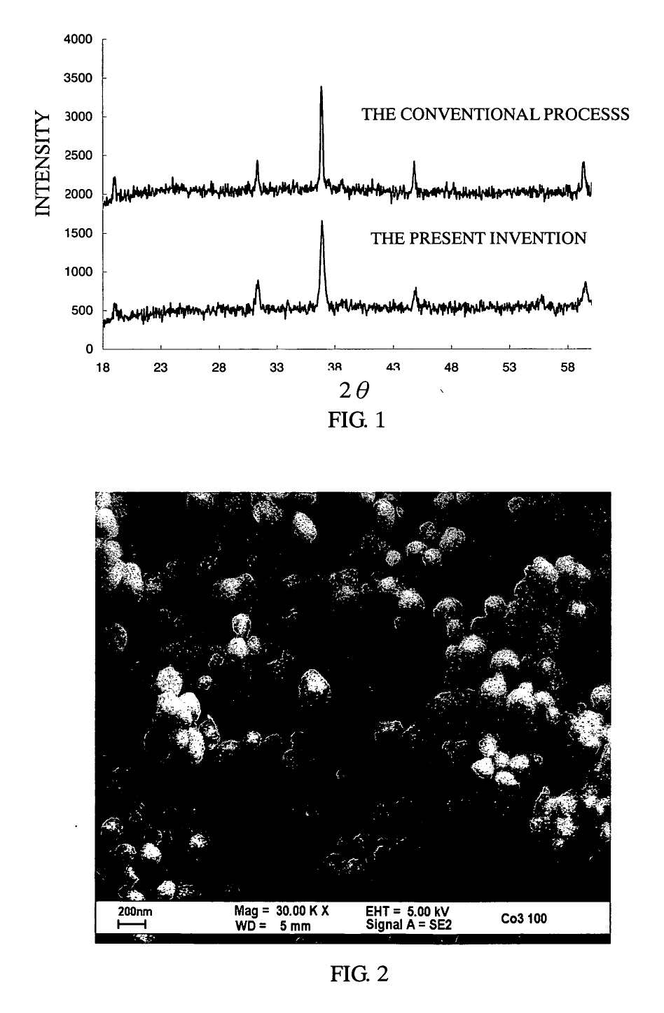

FIG. 1 shows the X-ray diffraction spectra of the tricobalt tetraoxide powders prepared in Example 1 and prepared by the conventional calcination process. It can be seen from FIG. 1 that both powders have the same characteristic peaks, indicating that they are the same product of tricobalt tetraoxide. FIG. 2 shows a scanning electron microscope (SEM) photograph of the tricobalt tetraoxide powder prepared in Example 1. In can be seen from FIG. 2 that the grains of the powder are spherical and mostly smaller than 200 nm.

### EXAMPLE 2

The procedures in Example 1 were repeated except that the introduction of the oxygen stream was replaced by an addition of 7.353 g potassium perchlorate (KClO₃).

### EXAMPLE 3

The procedures in Example 1 were repeated except that the reactor equipped with a refluxing device was replaced by an autoclave.

Tricobalt tetraoxide powders similar to that prepared in Example 1 were obtained in Examples 2 and 3.

1. A process for preparing tricobalt tetraoxide comprising the following steps:
a) reacting a water soluble cobaltous compound and a alkali metal hydroxide, alkali metal salt, ammonium hydroxide or ammonium salt in water to form cobaltous hydroxide;
b) reacting the resulting reaction mixture from step a) and an oxidant at a temperature of 50-100° C. and under refluxing or under a hermetic high pressure condition to form a tricobalt tetraoxide powder;
c) solid-liquid separation of the resulting reaction mixture from step b); and
d) washing the powder recovered from step c) with water and drying the washed powder.

2. The process according to claim 1, wherein step a) comprises reacting cobaltous sulfate, cobaltous chloride or cobaltous nitrate and sodium hydroxide at a pH value of 10-13.

3. The process according to claim 1, wherein said oxidant in step b) is oxygen, potassium permanganate, potassium perchlorate or hydrogen peroxide.

4. The process according to claim 3, wherein said oxidant in step b) is oxygen, and said reaction in step b) is carried out at a temperature of 90-100° C. and under refluxing.

5. The process according to claim 3, wherein said oxidant in step b) is potassium perchlorate, and said reaction in step b) is carried out at a temperature of 90-100° C. and under refluxing.

6. The process according to claim 3, wherein said oxidant in step b) is oxygen, and said reaction in step b) is carried out at a temperature of 90-100° C. and in an autoclave.

7. The process according to claim 1, wherein said solid-liquid separation in step c) is filtration.

8. The process according to claim 1, wherein said tricobalt tetraoxide powder has substantially spherical grains with an average diameter less than 200 nm.
